(19) United States
(12) Patent Application Publication
(10) Pub. No.: US 2009/0241282 A1
(43) Pub. Date: Oct. 1, 2009

(54) Windshield wiper blade element having improved anti-chatter properties

(76) Inventor: Michel Marc, Lenexa, KS (US)

Correspondence Address: Barry R. Blaker, 4 Algonquin Road, Acton, MA, 01720, US

(21) Appl. No.: 12/319,095

(22) Filed: Dec. 31, 2008

Related U.S. Application Data
(63) Continuation-in-part of application No. 12/079,108, filed on Mar. 25, 2008, now abandoned.

(51) Int. Cl. B60S 1/38

(52) U.S. Cl. 15/250.48

(57) ABSTRACT

Disclosed herein is a windshield wiper blade element having improved anti-chatter and cleansing properties. The elongate rubbery blade element has a pair of opposed channels to impart angular flexibility adjacent the blade root and a bottom edge section defining a squeegee element having the cross sectional geometry of a mature inverted mushroom cap. In use, the squeegee element having this geometry provides a beneficial scraping action during the cleansing sweep of the blade element over the glass surface, thereby aiding in the removal of soft detritus.

### CROSS-REFERENCE TO RELATED APPLICATION

This application is a continuation-in-part of application Ser. No. 12/079,108, filed Mar. 3, 2008.

### BACKGROUND OF THE INVENTION

The present invention relates broadly to vehicular windshield wipers and is more particularly concerned with a wiper blade element having improved anti-chatter properties.

The typical present day windshield wiper blade arrangement comprises a wiper arm having a driven end and a sweeping end. To the sweeping end of said wiper arm there is pivotally affixed a wiper blade assembly comprising an elongate metallic or plastic blade carrier having dependingly affixed thereto an elongate rubber or elastomeric blade element. Reference is now made to FIG. 1 hereof wherein there is shown, in cross sectional view, a generalized wiper blade assembly of the prior art sweeping in a left-hand direction across a glass surface. Said wiper blade assembly 1 comprises a blade carrier 2 composed of an inverted channel member 3 which houses therewithin a longitudinally split spline element 4. Captured within the central split 5 of said spline element 4 is the root 7 of an elongate rubber or elastomeric blade element 6 having a top edge section 8 defining said blade root 7, an intermediate web section 9 of generally decreasing thickness from its top to bottom and a relatively thin flat bottom edge section 10 the free edge 11 of which defines the glass contacting squeegee element of the construction.

In use, the wiper arm (not shown), which is conventionally equipped with one more springs which, acting through the wiper blade assembly 1, continuously bias the blade element 6 against the glass surface 100, is swept to and fro, in a cyclic or reciprocating manner, across said surface 100. As shown in FIG. 1, when the blade carrier 2 is driven in the left-hand direction, it is in the nature of things that the elongate blade element 6 flexes to the right and thus the bottom edge section 10 thereof trails slightly to the right of the centerline, C_{L}, of the top edge section 8 as the blade element 6 is swept in a left-hand direction over the glass surface 100. In this flexed trailing condition, the squeegee edge 11 rides in smooth and continuous contact over the glass surface 100 and thus provides effective wiping and cleansing thereof. In proper operation, when the sweep cycle changes and the blade carrier 2 is driven in the reciprocal or right-hand direction, the entire length of the intermediate web section 9 and the bottom edge section 10 of the elastomeric or plastomeric blade element 6 are caused to overcenter, thereby to flex to the left and to thereby reestablish this desired trailing relationship of the bottom edge section 10 with respect to the centerline, C_{L}, of the blade root 7.

Unfortunately, over time, and due to any one or number of factors such as wear and tear of the wiper assembly linkages, dirt build-up or age or oxidative hardening of the rubber blade element 6 or the vibration mounts for the wiper motor, it often occurs that a portion or the entirety of the length of the intermediate web section 9 and bottom edge section 10 of the blade element 6 fail to overcenter and reverse their flexure upon changeover of the wiper sweep from one direction to the other and, as a result, the so affected portion of the squeegee edge 11 precedes, rather than trails, the centerline of the blade root 7 during one or the other of the reciprocal sweeps of the blade element 6 over the glass surface 100. Upon such occurrence, the tendency of the squeegee edge 11 is to chatter rather than to ride smoothly over the glass surface 100. The resulting chatter noise is, of course, bothersome to the occupants of the vehicle. Of even greater importance, however, the cleansing ability of the blade element 6 is very substantially degraded and severe, dangerous obscuration of the windshield can occur very quickly, particularly in muddy, snowy or icing conditions. In accordance with the present invention, however, this deleterious phenomenon of blade chattering has been substantially completely resolved or, at the least, very substantially ameliorated

It is a principal object of the present invention to provide a novel windshield wiper blade element.

It is another object of the invention to provide a windshield wiper blade element having improved resistance to chattering.

It is still another object of the invention to provide a windshield wiper blade element having improved service life.

It is yet another object of the invention to provide a windshield wiper blade element having improved longevity of cleansing efficiency.

Other objects and advantages of the present invention will, in part, be obvious and will, in part, appear hereinafter.

### BRIEF SUMMARY OF THE INVENTION

In accordance with the invention there is provided a windshield wiper blade element comprising an elongate strip of an elastomeric or plastomeric material, said strip having a top edge section defining a blade root, a bottom edge section defining a squeegee element and an intermediate web section of generally decreasing thickness from said top section to said bottom section. At the juncture of said top and intermediate sections is a pair of opposed inwardly extending channels of a size and shape to define therebetween a relatively thin flexible wall connecting said top edge section to said intermediate section. Said connecting wall fosters angular side to side flexure of said intermediate web section relative to the centerline of said blade root and, in a preferred embodiment of the invention, said channels are sized and shaped to limit such angular flexure to about 30° to each side of the centerline of the blade root. The bottom edge section defining the squeegee element has a pair of laterally extending flanges and a cross sectional shape of a mature inverted mushroom cap.

### THE DRAWINGS

FIG. 1 is a schematic, diagrammatic cross sectional view of a generalized wiper blade assembly of the prior art shown in contact with a glass surface and sweeping to the left.

FIG. 2 is a schematic, diagrammatic cross sectional view of a wiper blade element in accordance with one embodiment of the present invention.

FIG. 3 is a schematic, diagrammatic cross sectional view of the wiper blade element of FIG. 2 shown in contact with a glass surface and sweeping to the right.

FIG. 4 is a schematic, diagrammatic isometric view of a portion of the wiper blade element of FIG. 2.

FIG. 5 is a schematic, diagrammatic cross sectional view of a wiper blade element in accordance with another embodiment of the invention.

### DETAILED DESCRIPTION OF THE INVENTION

The wiper blade element in accordance with the invention can be composed of substantially any suitable rubbery or soft, flexible polymer composition such as: natural rubber, butadiene rubber, styrene-butadiene rubber, nitrile rubber, chlorinated rubbers such as neoprene, polysulfide rubbers, silicone rubber, polyolefin homopolymers, copolymers such as polytetrafluoroethylene, polypropylene, polyethylene/polypropylene copolymers and blends thereof and the like. Moreover, the construction of the invention is amenable to fabrication by well known conventional polymer forming techniques, such as extrusion, compression molding or injection molding.

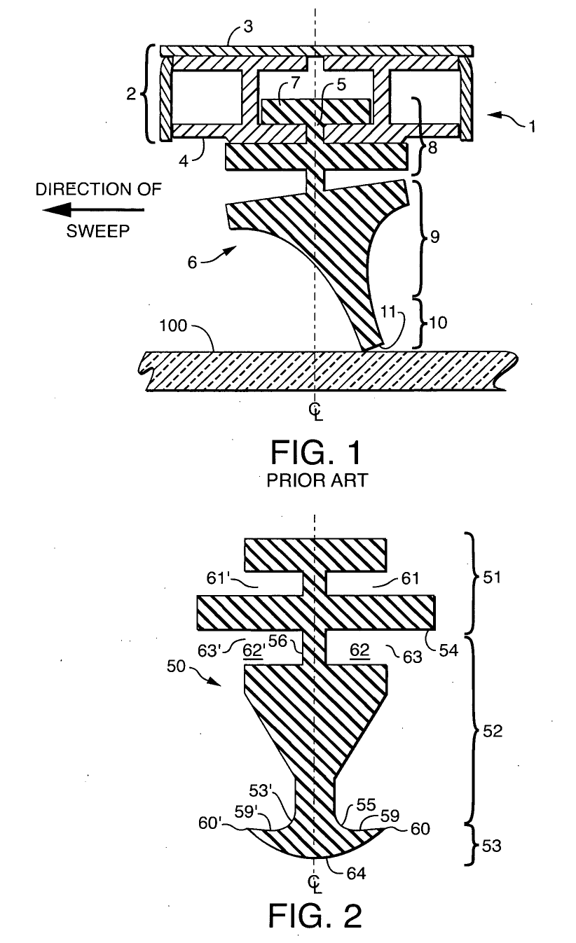

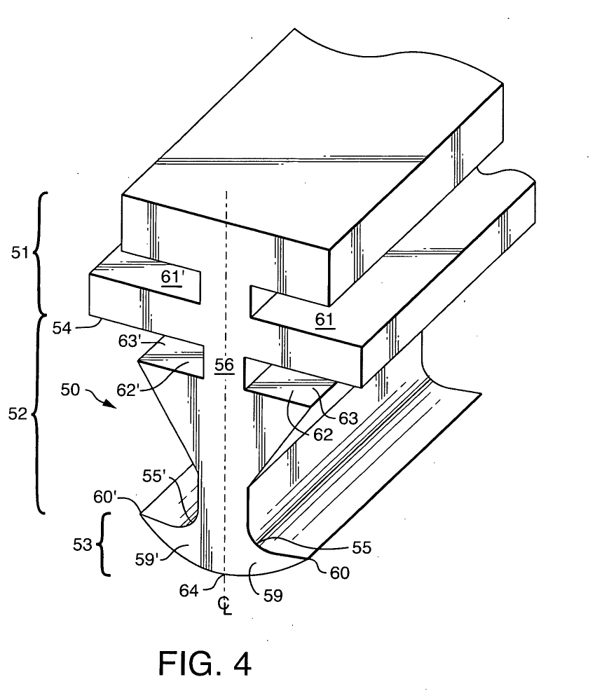

Turning now to FIGS. 2 through 4 hereof, wherein like reference numerals refer to like structures, there is shown a wiper blade element 50 in accordance with the invention and which comprises an elongate strip of rubbery material having a top edge section 51 which is suitably conformed, such as by opposed lateral grooves 61, 61′, so as to be adapted to be secured to a blade carrier and which top edge section 51 thus defines a blade root. In addition, said wiper blade element 50 comprises a bottom edge section 53 having lateral flanges 59, 59′ defining an inverted mushroom shaped squeegee element and an intermediate web section 52 whose thickness generally decreases from its juncture 54 with said top edge section 51 to its radiused junctures 55, 55′ with said bottom edge section 53. The aforementioned generally decreasing thickness of said intermediate web section 52 results, of course, in a desirable essentially progressive increase in lateral flexibility of the blade element as the bottom edge section 53 thereof is approached from above.

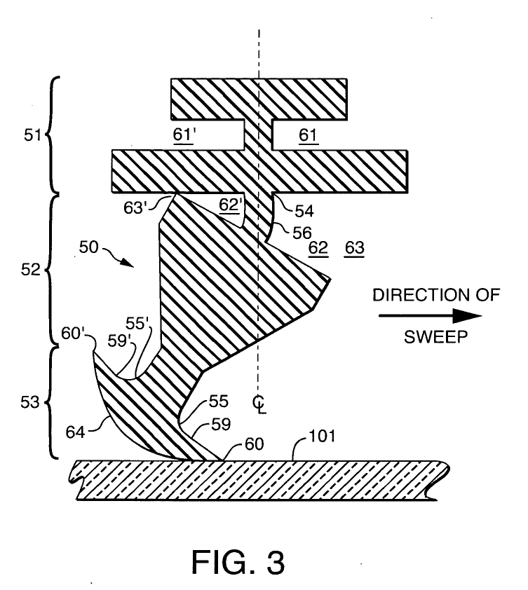

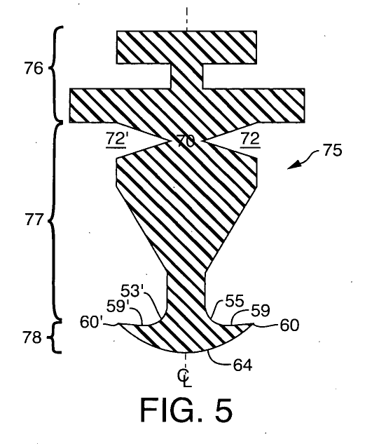

At the juncture 54 of said top edge section 51 with said intermediate web section 52 are a pair of opposed channels 62, 62′ which, in FIGS. 2-4 are rectilinear in shape, and whose depths are sufficient so as to define therebetween an angularly flexible central wall 56 connecting said intermediate web section 52 to said top edge section 51. The provision of such angular flexibility by said connecting central wall 56 is an important feature in initiating or fostering the overcentering phenomenon mentioned previously, thus contributing to the anti-chatter properties of the wiper blade element of the invention. In addition, it is highly desirable that said channels 62, 62′ be shaped and dimensioned such that limit stops are defined by which said angular flexure of said connecting central wall 56 is limited to no greater than about 30° and, even more preferably, to no greater than about 15° to either side of the centerline, C_{L}, of top edge section 51 As is best shown in FIG. 3, this function can be readily provided by appropriate dimensioning of the lateral openings 63, 63′ of the opposed channels 62, 62′ such that, upon such flexure to the selected limit, the opening 63 or 63′, as the case may be, closes, thereby to mitigate against flexure to beyond said selected limit. Alternatively, however, and as shown in the embodiment of the invention depicted in FIG. 5, this flexure limiting function can also be served by a wiper blade element 75 having opposed channels 72, 72′ of V-shaped geometry interposed between the top edge section 76 and intermediate web section 77, thereby to define an angularly flexible central wall 70 therebetween and wherein the included angle defined by each of said V-shaped channels 72, 72′ is, preferably, no greater than about 30° and, of even greater preference, no greater than about 15°.

Returning to the embodiment of the invention shown in FIGS. 2 through 4 the invention the bottom edge section 53 of the wiper blade element 50 has the cross sectional geometry of a mature inverted mushroom cap. Said geometry is defined by a bottom edge section 53 structure comprising a pair of substantially lateral, coextensive upper surfaces 59, 59′ which extend substantially perpendicularly from said intermediate web section 52 and whose respective junctures 55, 55′ with said intermediate web section 52 are smoothly radiused. The bottom surface 64 of said inverted mushroom shaped bottom edge section 53 is convexly and upwardly arcuate and meets the respective peripheries of said substantially lateral upper surfaces 59, 59′ so as to define therebetween sharp or knife edges 60, 60′, respectively. Said convexly arcuate surface 64 can be of circular or parabolic geometry. As is best observed in FIG. 3, it is said knife edges 60, 60′ which contact the glass surface 101 during the sweeping portions of the reciprocating wiper cycle and which thus serve the principal squeegee function of the construction. Moreover, under the blade flexures which occur during the sweeping portions of said cycle, said convexly arcuate bottom surface 64 also serves to establish and maintain said knife edges 60, 60′ in a desirable scraping contact with said glass surface whereby soft detritus, such as mud and insect splatter, is effectively removed.

While the invention has been described hereinbefore with respect to certain preferred embodiments thereof, it should be noted and understood that the foregoing disclosure, including the drawings forming part hereof, are intended to be illustrative in nature and are not to be deemed as limiting of the invention. It should be further noted and understood that many obvious changes, variations, modifications and the like may be made in the hereinbefore described embodiments of the invention without departing from the essential scope and spirit thereof. Accordingly, it is intended that the invention be limited solely by the scope and content of the appended claims.

What is claimed is:

1. In a windshield wiper blade element comprising an elongate strip of a rubbery material, said strip having top and bottom edge sections and an intermediate web section, said top edge section having a centerline and being conformed to define a blade root securable to a wiper blade carrier, said bottom edge section defining a squeegee element for wiping contact with a windshield and said intermediate web section being of generally decreasing thickness from said top section to said bottom section, the improvement which comprises, in combination:
(A) a pair of lateral opposed channels extending inwardly from each side of said strip and being located at the juncture of said top edge section and said intermediate web section, each said lateral channel having a lateral opening and said pair of channels defining therebetween an angularly flexible connecting wall between said top edge section defining said blade root and said intermediate web section; and
(B) said bottom edge section defining said squeegee element having a cross sectional geometry of a mature inverted mushroom cap.

2. The improvement of claim 1 wherein each of said laterally opposed channels includes stop means adapted to prevent angular deflection of said connecting wall relative to said centerline of greater than about 30°.

3. The improvement of claim 1 wherein each of said laterally opposed channels includes stop means adapted to prevent angular deflection of said connecting wall relative to said centerline of greater than about 15°.

4. The improvement of claim 2 wherein said stop means comprises the lateral opening of each said channel being dimensioned such that said opening closes upon angular flexure of said connecting wall relative to said centerline of greater than about 30°.

5. The improvement of claim 3 wherein said stop means comprises the lateral opening of each said channel being dimensioned such that said opening closes upon angular flexure of said connecting wall relative to said centerline of greater than about 15°.

6. The improvement of claim 2 wherein each said laterally opposed channel is V-shaped and has an included angle of no greater than about 30°.

7. The improvement of claim 3 wherein each said laterally opposed channel is V-shaped and has an included angle of no greater than about 15°.

8. The improvement of claim 1 wherein said mushroom cap shaped bottom edge section has a convexly arcuate bottom surface of circular geometry.

9. The improvement of claim 1 wherein said mushroom cap shaped bottom edge section has a convexly arcuate bottom surface of parabolic geometry.
